(19) United States
(12) Patent Application Publication
(10) Pub. No.: US 2021/0130719 A1
(43) Pub. Date: May 6, 2021

(54) SULFUR MANAGEMENT METHOD

(71) Applicant: OXY USA INC., Houston, TX (US)

(72) Inventors: Robert L. ZELLER, Seabrook, TX (US); Ronald M. WEINER, Bellaire, TX (US); Mikhail TANAKOV, Houston, TX (US)

(21) Appl. No.: 16/639,578

(22) PCT Filed: Aug. 15, 2018
(86) PCT No.: PCT/US2018/000168

§ 371 Date: Feb. 16, 2020

Related U.S. Application Data
(60) Provisional application No. 62/545,605, filed on Aug. 15, 2017.

(51) Int. Cl. C10L 3/10; C01B 17/04; C01B 17/50; C01B 17/90; C01F 11/46; C09K 8/58; C09K 8/532

(52) U.S. Cl. CPC C10L 3/103; C01B 17/0404; C01B 17/50; C10L 2290/141; C01F 11/464; C09K 8/58; C09K 8/532; C01B 17/90

(57) ABSTRACT

A method of managing sulfur in a sulfur-containing stream may include steps of providing a sulfur-containing stream; converting sulfur within the sulfur-containing stream to elemental sulfur; transporting the elemental sulfur to a location at or near a sulfur oxide injection location; converting the elemental sulfur to sulfur oxides; recovering electrical energy from said step of converting the elemental sulfur to sulfur oxides; injecting the sulfur oxides into the sulfur oxide injection location. The method may include steps of screening a plurality of injection locations and selecting, from the screened plurality of injection locations, a particular sulfur dioxide injection location with specific reservoir characteristics for the sulfur oxides.

This application claims the benefit of U.S. Provisional Application Ser. No. 62/545,605 filed on Aug. 15, 2017, which is incorporated herein by reference

### FIELD OF THE INVENTION

Embodiments of the present invention are directed towards methods of managing the sulfur contained within a hydrocarbon production or byproduct stream. In certain embodiments, sulfur-containing compounds are converted to elemental sulfur, transported to desired location, converted to liquid or gaseous sulfur oxides, and then injected into geological formations. Particular embodiments include a method whereby a particular injection location is selected based on a desired result to be achieved by the injecting the liquid or gaseous sulfur oxides. For example, in certain embodiments, the result to be achieved is the sequestering of sulfur in a geological formation. In other embodiments, the composition of a natural gas field can be altered by injection of the sulfur oxides; e.g. sour gas can be sweetened.

### BACKGROUND OF THE INVENTION

Natural gas production often includes the production of sour gas, which is a hydrocarbon gas that includes appreciable levels of hydrogen sulfide and carbon dioxide. Conventionally, the desired hydrocarbons within the sour gas stream are separated from hydrogen sulfide by one or more separation processes, which are generally referred to as acid gas removal or gas sweetening processes. Examples of gas sweetening processes include amine absorption processes and membrane separation.

The by-product stream of a gas sweetening process is typically a gaseous stream that includes relatively high levels of hydrogen sulfide, residual hydrocarbon, and often some level of carbon dioxide. Conventionally, this by-product stream, which is often referred to as an acid gas stream, is typically treated to convert the hydrogen sulfide to elemental sulfur. A well-known process for the treatment of acid gas streams is the Claus process, which oxidizes at least a portion to hydrogen sulfide to sulfur dioxide, and then sulfur dioxide and hydrogen sulfide are reacted to produce elemental sulfur and water. The resultant elemental sulfur is then typically sold to other industries, such as the agrochemical industry, stockpiled to await changes in market conditions (temporary storage), or landfilled. The amount of sulfur produced from the production and isolation of hydrocarbons has led to large surpluses of elemental sulfur.

In order to address the surpluses in elemental sulfur, several technologies have been proposed. For example, U.S. Pat. No. 7,282,193 proposes a process that produces liquid elemental sulfur using a process generally similar to the Claus process, and then oxidizes the elemental sulfur to produce energy and sulfur dioxide. The '193 patent touts efficiencies that can be achieved by recycling the sulfur dioxide produced from the oxidation of elemental sulfur back to the Claus process, which step reduces demand on initially converting hydrogen sulfide within the acid gas stream to sulfur dioxide. Where excess sulfur dioxide is produced in the oxidation of elemental sulfur, the '193 suggests disposal of the excess sulfur dioxide.

U.S. Pat. No. 8,518,357 discloses a method of oxidizing hydrogen sulfide or elemental sulfur to create a flue gas including sulfur oxides, where the sulfur oxides are absorbed into an aqueous solution, and then the sulfur oxides are further oxidized to form a sulfuric acid solution. The sulfuric acid is then neutralized using alkaline materials to form a brine material, which can then be disposed of by releasing it into a saline water body or injecting it into a geologic formation.

The processes that have been proposed thus far rely on the oxidation of elemental sulfur to sulfur dioxide as a means of consuming the elemental sulfur. The presence of sulfur dioxide, however, presents several issues since sulfur dioxide is a toxic substance that can have one or more disadvantageous effects on living organisms or the environment. As a result, the processes proposed thus far suffer from limitations associated with handling of sulfur dioxide, especially as it pertains to the transport of sulfur dioxide from the location where the sulfur dioxide is produced to a location where the sulfur dioxide is disposed.

### SUMMARY OF THE INVENTION

One or more embodiments of the present invention provide a method of managing sulfur in a sulfur-containing stream comprising the steps of (i) providing a sulfur-containing stream; (ii) converting sulfur within the sulfur-containing stream to elemental sulfur; (iii) transporting the elemental sulfur to a location at or near a sulfur-oxide-injection location; (iv) converting the elemental sulfur to sulfur oxides; (v) recovering electrical energy from said step of converting the elemental sulfur to sulfur oxides; and (vi) injecting the sulfur oxides into the sulfur oxide injection location.

Yet other embodiments of the present invention provide a method of managing sulfur within a sour gas stream, the method comprising the steps of (i) transporting elemental sulfur from a first location to a location at or near a geological formation designated for sulfur sequestration; (ii) combusting the sulfur at the location at or near the geological formation to thereby produce a combustion stream including sulfur dioxide; (iii) routing the combustion stream through a heat recovery unit to extract heat from the combustion stream; (iv) producing electrical energy from the extracted heat; (v) liquefying the sulfur oxides within the combustion stream to produce a liquefied sulfur oxides stream, and (vi) selecting, from a plurality of injection locations, a particular sulfur oxides injection location; and (vii) injecting the liquefied sulfur oxides stream into the particular sulfur oxides injection location.

Still other embodiments of the present invention provide a method of sequestering sulfur within a sour gas stream, the method comprising the steps of (i) providing a sour gas stream including hydrocarbons, carbon dioxide and hydrogen sulfide; (ii) separating the hydrocarbons from the sour gas stream to produce a hydrocarbon stream and an acid gas stream including hydrogen sulfide; (iii) oxidizing the hydrogen sulfide within the acid gas stream to produce sulfur oxides; (iv) reacting the sulfur oxides with hydrogen sulfide to produce elemental sulfur; (v) transporting the elemental sulfur to a location at or near desired geological formation; (vi) combusting the elemental sulfur at or near the geological formation to thereby produce a combustion stream including sulfur oxides; (vii) routing the combustion stream through a heat recovery unit to extract heat from the combustion stream and transfer the heat to a water or low-pressure steam stream to thereby form high pressure steam; (viii) routing the steam to a turbine to thereby produce electrical energy; (ix) liquefying the sulfur oxides within the combustion stream to produce a liquefied sulfur oxides stream, and (x) injecting the liquefied sulfur oxides stream into the geological formation to thereby achieve sequestration of the sulfur oxides.

### BRIEF DESCRIPTION OF THE DRAWINGS

FIG. 1 is a flow chart representation of a process according to one or more embodiments of the present invention.

FIG. 2 is a flow chart representation of a process according to one or more embodiments of the present invention.

### DETAILED DESCRIPTION OF ILLUSTRATIVE EMBODIMENTS

Embodiments of the invention are based, at least in part, on methods of managing the sulfur contained within a hydrocarbon production stream. In one or more embodiments, sulfur compounds within a hydrocarbon production stream are converted to elemental sulfur and then shipped to locations at or near a location where the sulfur can be converted to sulfur oxides (e.g. sulfur dioxide and/or sulfur trioxide) and then injected into an injection formation such as a geological formation. The processes of this invention therefore advantageously allow for the relatively safe transport of the sulfur (in the form of elemental sulfur) from a location where it is formed, such as oil refineries, to a location where the sulfur oxides can be injected without the need to transport sulfur oxides. In particular embodiments, the methods of managing sulfur advantageously include a step of oxidizing elemental sulfur for the production of energy at or near a location where the resultant sulfur oxides can be injected (e.g. as liquids) into an injection location. Among the advantages is the fact that electrical energy, which may be needed at or near the injection site, does not need to be transported to the injection site from remote power-generation facilities. Thus, while the prior art may contemplate the oxidation of elemental sulfur as an enhancement of acid-gas treatment processes (e.g. Claus processes), the present invention takes advantage of the transportability of the elemental sulfur to provide a novel method of managing sulfur by injecting sulfur oxides in an injection location while also generating electricity.

Further, embodiments of the present invention include the step of selecting a particular injection location based on one or more desired results to be achieved by the injection of sulfur oxides into an injection location. Exemplary results to be achieved include forming sulfur-containing minerals (e.g. gypsum or calcium sulfite) in the injection location, sequestering the sulfur oxides (e.g. within an otherwise depleted or partially depleted oil or gas reservoir), improving the quality (e.g. sweetening) of a downhole gas (e.g. natural gas containing hydrogen sulfide), and using sulfur oxides with an enhanced oil recovery (EOR) process. Embodiments of the present invention may achieve more than one desired result. While the prior art may contemplate certain results to be achieved for a singular sulfur dioxide injection location, the present invention advantageously provides for the selection of a particular injection location among many injection locations to achieve a desired goal.

### Process Overview

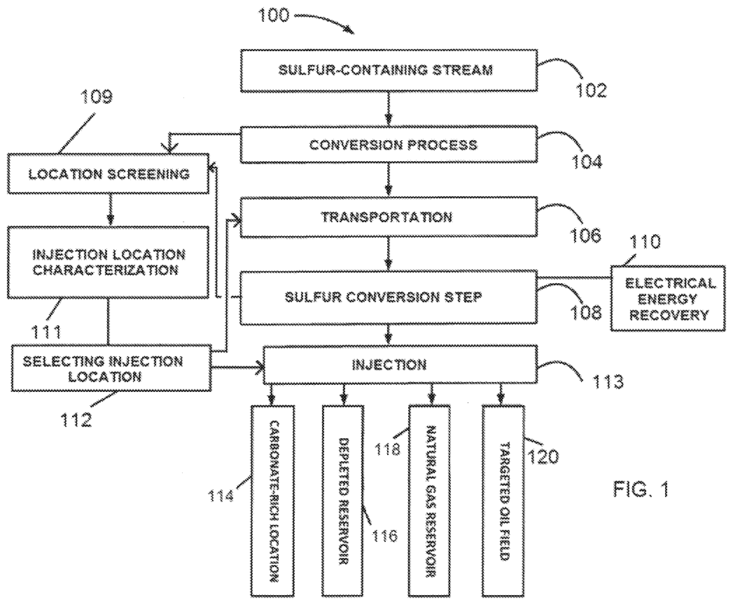

Embodiments of the invention may be described with reference to FIG. 1, which shows a sulfur management method 100, which may also be referred to as a sulfur recovery method 100 or a sulfur sequestration method 100. A sulfur-containing stream 102 is provided to a conversion sub-process 104, wherein sulfur within sulfur-containing stream 102 may be converted to elemental sulfur. Sulfur-containing stream 102 may be a hydrocarbon production stream or byproduct stream. Sulfur within sulfur-containing stream 102 may be in the form of H₂S, or other known sulfur-containing compounds. In one or more embodiments, conversion sub-process 104 includes oxidizing sulfur compounds, such as H₂S, within stream 102, to form sulfur oxides, such as sulfur dioxide or sulfur trioxide, and then reacting the sulfur oxides with H₂S to form elemental sulfur.

The elemental sulfur from conversion sub-process 104 may be provided to a transportation step 106, wherein the elemental sulfur is transported to a location at or near an injection location, which may also be referred to as geological formation, subterranean formation, or injection site. As used herein, “at or near an injection location” refers to a location within sufficient proximity of the injection location so that intermediary pumps or boosters can be avoided. The benefits associated with this proximity will be readily apparent to those skilled in the art since the transport of sulfur oxides (e.g. sulfur dioxide) can present many challenges even when transported by pipeline. Accordingly, several advantages relative to the transport of sulfur oxides can be realized including, but not limited to, the avoidance of transporting (including piping) sulfur oxides across roadways and waterways. In one or more embodiments, elemental sulfur is transported and converted to sulfur oxides at a location within 25 miles, in other embodiments within 15 miles, and in other embodiments within 10 miles of the injection location.

After the elemental sulfur has been transported to a location at or near the injection location, the elemental sulfur is converted to sulfur oxides, such as sulfur dioxide, within a sulfur conversion step 108, which may also be referred to as a sulfur burning step 108. Advantageously, an electrical-energy-recovery process in step 110 may generate electrical energy from the sulfur conversion step 108. In one or more embodiments, electrical-energy-recovering step 110 may include a heat recovery unit that extracts heat from conversion step 108 and produces electrical energy from the extracted heat. In one or more embodiments, electrical-energy-recovering step 110 may include routing a combustion stream through a heat recovery unit to extract heat from the combustion stream and transfer the heat to a water or low-pressure steam stream to thereby form steam, which can be routed to a turbine to thereby produce electrical energy. As the skilled person will appreciate, the combustion of elemental sulfur produces sulfur oxides, such as sulfur dioxide and sulfur trioxides.

Following sulfur conversion of the elemental sulfur to sulfur oxides in step 108, the sulfur oxides are injected into an injection location within an injection step 113. Those skilled in the art will appreciate that there are a variety of methods that may be employed to inject sulfur oxides into a geological formation. Typically the method selected will be dictated by the end goal desired by the injection.

Prior to or in conjunction with one or more of the foregoing steps, the processes of this invention may include a location screening step 109 whereby an injection location is identified for the injection of sulfur oxides. This may include identification of one or more injection locations ultimately deemed more preferable for injection of sulfur oxides. Location screening step 109 may include, or may be followed by, a characterization step 111 whereby the conditions or characteristics of one or more potential locations or identified locations is determined. These conditions or characteristics may be relevant to the suitability of the injection locations for sulfur oxides or may be relevant to the results that can be achieved by injecting sulfur oxides. For example, characterization step 111 may indicate that a particular injection location includes a carbonate reservoir, and therefore this particular injection location may be chosen from a plurality of identified injection locations, which may be identified in step 109, based upon a goal of producing calcium sulfate, calcium sulfite, or hydrated forms of calcium sulfate (e.g. gypsum) or calcium sulfite in the injection location. Accordingly, characterization step 111 may be followed by a selection step 112 wherein an injection location is selected. Once a location has been selected, the sulfur oxides are then injected according to injection step 113.

As described above, sulfur oxides, such as sulfur dioxide, can be injected into a carbonate-rich location 114 based on a desired result of forming calcium sulfate, calcium sulfite, or hydrated forms of calcium sulfate or calcium sulfite, within the injection location. In other embodiments, sulfur oxides can be injected into a depleted reservoir 116 based upon a desired result of sequestering the sulfur oxides. In other embodiments, sulfur oxides can be injected into a natural gas reservoir 118 that is rich in hydrogen sulfide based on a desired result of improving the quality of a downhole sour gas (i.e. gas sweetening). In yet other embodiments, sulfur oxides can be injected into a targeted oil field 120 based on a desired result of using sulfur dioxide for enhanced oil recovery (EOR).

In one or more embodiments, step 109, step 111, and step 112 proceed in parallel with one or more of the other steps 102, 104, 106, 108. That is, in one or more embodiments, step 109, step 111, and step 112 may proceed independently from steps 102, 104, 106, 108. In one or more embodiments, step 109, step 111, and step 112 proceeding concurrently with steps 102, 104, 106, 108, or step 109 may proceed without requiring an input from step 104.

### Specific Embodiments

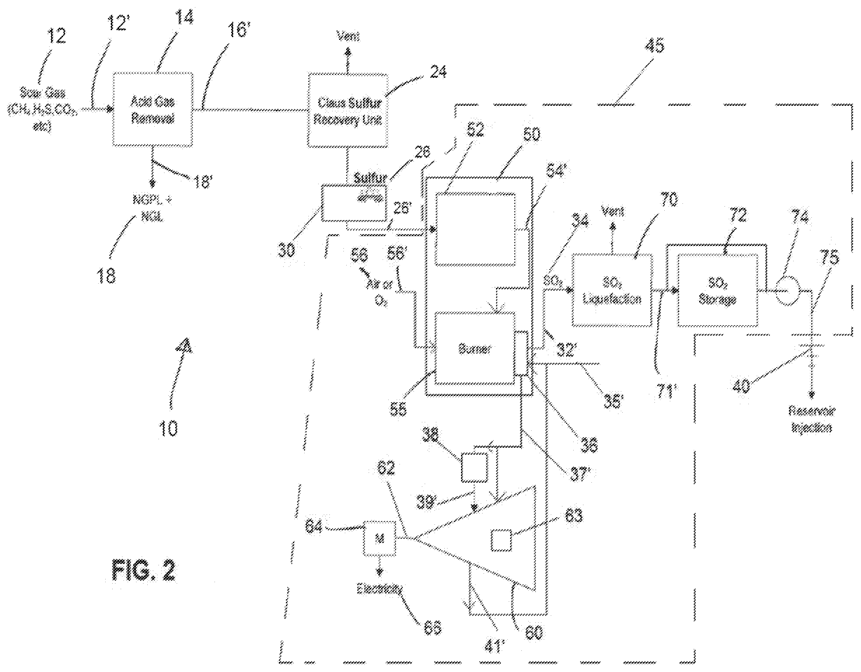

Embodiments of the invention may be described with reference to FIG. 2, which shows a sulfur management method 10, which may also be referred to as a sulfur recovery method 10 or a sulfur sequestration method 10.

A sour gas feed stream 12′, which may also be referred to as a sulfur-containing stream 12′, provides sour gas 12 to an acid gas removal step 14, which may also be referred to as gas sweetening step 14. Sour gas feed stream 12′ may be a hydrocarbon production stream or byproduct stream. Within gas sweetening step 14, hydrocarbons 18, such as natural gas (e.g. methane (CH₄)) and natural gas liquids, are separated as hydrocarbon stream 18′ from hydrogen sulfide (H₂S) and other non-hydrocarbon constituents, such as carbon dioxide (CO₂), and other residual gases, which form acid gas stream 16′. In one or more embodiments, gas sweetening step 14 may include those techniques that are generally known in the art including, but not limited to, amine treatments and membrane separation.

Acid gas stream 16′, which results from gas sweetening step 14, is then treated within acid gas treatment step 24 to convert hydrogen sulfide in acid gas stream 16′ to elemental sulfur (S) 26, which may simply be referred as sulfur 26. In one or more embodiments, the techniques used to convert hydrogen sulfide within acid gas stream 16′ to sulfur 26 may include those techniques generally known in the art. For example, the Claus reaction, or derivatives thereof, may be employed. In this respect, U.S. Pat. Nos. 3,854,884; 3,895,101; 4,097,585; 4,426,369; 4,508,699; 4,620,967; 7,282,193; and 7,597,871, are all incorporated herein by reference.

Sulfur 26 is then transported in a transportation step 30 to a location 45 at or near an injection location 40, which may also be referred to as a geological formation 40, subterranean formation 40, or injection site 40. Transportation step 30 includes the transport of elemental sulfur 26 in its solid state. In one or more embodiments, transport may include, but is not limited to, movement by rail car, truck, or seagoing vessel. In other embodiments, the elemental sulfur may be converted to its liquid phase or state, such as by heating, and then transported as a liquid such as by way of pipeline, which will require keeping the elemental sulfur in its liquid phase at elevated temperature and/or pressure.

After sulfur 26 is transported to location 45 at or near injection location 40, sulfur 26 is oxidized at location 45 to form sulfur oxides within sulfur oxidation step 50, which may also be referred to as sulfur burning step 50 or sulfur conversion step 50. In one or more embodiments, sulfur 26 may be converted to sulfur oxides in a non-combustion method, which methods are generally known to those skilled in the art.

Sulfur oxidation step 50 may be accomplished by employing techniques known in the art. For example, in particular embodiments, sulfur 26, in the form of sulfur stream 26′, is first heated above its melting point within heating step 52 to provide a flowable or pumpable stream 54′ of liquid sulfur. Heating step 52 may include heating sulfur 26 to temperatures of from about 130° C. to about 145° C.

In one or more embodiments, stream 54′ of liquid sulfur is fed to one or more burners 55 together with an oxidant stream 56′, which supplies one or more oxidants 56. Oxidants 56 may include, without limitation, pure oxygen, air, or an oxygen enriched air stream from, for example, one or more air separation units (not shown). Burners 55 may include those that are known in the art including, but not limited to, those disclosed in U.S. Pat. Nos. 2,807,522; 3,149,916; 5,807,530; 7,674,449; and 8,043,597, which are each incorporated herein by reference. The skilled person will be able to readily operate known burners at conditions sufficient to convert elemental sulfur to sulfur oxides.

In one or more embodiments, energy obtained from sulfur oxidation step 50 can be used to generate electrical energy. For example, the oxidation of sulfur within sulfur burning step 50 produces a combustion stream 32′, which includes one or more sulfur oxides 34 including sulfur dioxide. Heat energy from combustion stream 32′ is routed through heat recovery unit 36, which may also be referred to as boiler 36. Boiler 36 receives water stream or low pressure steam stream 35′ and converts water stream 35′ to steam stream 37′. In one or more embodiments, steam stream 37′ may be routed through a steam superheater 38 to produce superheated steam stream 39′. Steam stream 37′, or superheated steam stream 39′, is then routed to a steam-driven turbine 60, which may include a turboexpander 63, for the generation of electrical energy. As those skilled in the art appreciate, steam turbine 60 extracts thermal energy from steam stream 37′ (or stream 39′) to do mechanical work on a rotating output shaft 62. The rotation of shaft 62 may then be used to drive an electrical generator 64 to create electricity 66, which may be routed using conventional means. Depleted steam stream 41′ exiting turbine 60 may be routed to boiler 36 as boiler feed water 35′.

In one or more embodiments, steam turbine 60 may include those turbines generally known to those skilled in the art. In this respect, U.S. Pat. Nos. 2,447,696; 3,150,487; 5,442,908; and 7,282,193, are each incorporated herein by reference.

In one or more embodiments, the generation of electrical energy from the energy released in combustion step 50 may be achieved without the use of a turbine, as generally known in the art. For example, in one or more embodiments, a heat recovery step may include steps of extracting, through a heat recovery unit, heat from the combustion or conversion of sulfur to sulfur dioxide, and producing electrical energy from the extracted heat without the use of a turbine (e.g., a Stirling Engine, thermoionic generator or thermoelectric materials that convert thermal energy to electrical energy directly).

Combustion stream 32′, which includes one or more sulfur oxides 34, including sulfur dioxide, is routed for injection to injection location 40.

In one or more embodiments, combustion stream 32′, after leaving heat recovery unit 36, may undergo pre-treatment before injection. For example, combustion stream 32′ maybe liquefied within a liquefaction unit 70. As the skilled person will appreciate, liquefaction unit 70 may alter the temperature and pressure of combustion stream 32′ to phase transfer sulfur oxides within stream 32′ to their liquid state and thereby form liquefied sulfur oxides stream 71′.

In one or more embodiments, liquefied sulfur oxides stream 71′ may be routed to storage vessel 72 prior to injection into geological formation 40. In one or more embodiments, storage vessel 72 may be pressurized, cooled, or both pressurized and cooled.

In one or more embodiments, liquefied sulfur oxides stream 71′ may be routed through one or more pumps 74 prior to injection into geological formation 40. In one or more embodiments, optional additives or other chemical agents, such as surfactants or viscosifiers, may be added to liquefied sulfur oxides stream 71′ prior to injection into geological formations 40. Where utilized, the viscosifiers may help achieve a better mobility ratio of injectant and produced fluids, thus reducing the amount of sulfur oxides cycling when utilized in EOR operations.

In one or more embodiments, a gaseous combustion stream 32′ may undergo further compression. This further compression may be designed such that subsequent injection will enable the gas phase sulfur dioxide to convert to liquid in situ at the temperatures and pressures of the injection reservoir 40.

Injection location 40 may include, without limitation, geologically stable and geologically isolated subterranean zones (e.g. subterranean formations). In particular embodiments, subterranean formation 40 may be an unconsolidated sand formation, a depleted gas reservoir, a depleted oil reservoir, a depleted gas and oil reservoir, an active gas reservoir, an active oil reservoir, or an active gas and oil reservoir. Subterranean formation 40 may have undergone a dilation mechanism, where the stress state in the rock reaches a shear failure condition, creating additional pore space for the injection.

In one or more embodiments, subterranean formation 40 may be a depleted reservoir. In one or more embodiments, geological formation 40 may include abandoned oil or gas wells. In one or more embodiments, subterranean formation 40 may be an active reservoir, for example, where EOR or gas sweetening is particularly desired.

### Calcium Sulfate and Sulfite

In one or more embodiments, a geological formation 40 may be selected for the particular result of producing sulfur-containing minerals. For example, sulfur-containing minerals may include, without limitation, the sulfide minerals such as pyrite (iron sulfide), cinnabar (mercury sulfide), galena (lead sulfide), sphalerite (zinc sulfide) and stibnite (antimony sulfide), as well as the sulfates, such as gypsum (calcium sulfate), alunite (potassium aluminum sulfate), and barite (barium sulfate). In particular embodiments, the sulfur-containing minerals targeted for formation include calcium sulfate, calcium sulfite, or hydrated forms thereof (e.g. gypsum). In these or other embodiments, geological formation 40 may include a carbonate reservoir. In these embodiments, the injected sulfur oxides may be permanently sequestered by way of a mineralization process, as shown in the below reactions:

SO₂+H₂O→H₂SO₃

CaCO₃2H₂SO₃→Ca (HSO₃)₂+H₂O+CO₂

Ca(HSO₃)₂+CaCO₃→2CaSO₃+H₂O+CO₂

CaCO₃+H₂SO₃→Ca SO₃+H₂O+CO₂

CaSO₃+4H₂O→CaSO₃.4H₂O

CaSO₃+½H₂O→CaSO₃.½H₂O

4CaSO₃+heat→3CaSO₄+CaS

CaS+2SO₂→CaSO₄+2S

CaSO₄+2H₂O→CaSO₄.2H₂O

CaSO₃+½O₂+2H₂O→CaSO₄.2H₂O

When the SO₂ contacts connate water present in the carbonate reservoir, it forms sulfurous acid. The sulfurous acid then reacts with carbonate matrix (e.g. limestone) to form a calcium sulfite that has a variety of stable hydrates. The oxidation of the sulfur dioxide or calcium sulfite may be catalyzed via a catalyst found in trace materials (e.g. alumina) in the carbonate reservoir. At suitable reservoir temperatures and pressures, the calcium sulfite may react to form gypsum, a very stable mineral. The CO₂ that is formed by certain of the reactions may act in a traditional manner for CO₂ floods, such as disclosed in U.S. Pat. No. 4,217,955, which is incorporated herein by reference. The above reactions may also be implemented at surface conditions (e.g. at a plant) for production of the mentioned minerals for subsequent use as construction materials.

### Sulfur Sequestration

In one or more embodiments, a geological formation 40 may be selected for the particular result of sequestering sulfur dioxide in an otherwise depleted or substantially depleted geological formation 40. The selection of suitable geological formations 40 for accomplishing this desired result is generally known to those skilled in the art. As used herein, the term “otherwise depleted or substantially depleted” includes a geological formation that contains sufficient pore space for injection of sulfur dioxide. The term “otherwise depleted or substantially depleted” may include amounts of hydrocarbons that are not deleterious for the injection of sulfur oxides for the purpose of sequestration.

In one or more embodiments, sequestering sulfur oxides in an otherwise depleted or substantially depleted geological formation 40 may be characterized as long-term sequestration of sulfur oxides. In one or more embodiments, “long-term” sequestration may be defined as the sulfur oxides remaining sequestered for several years or decades depending on the size and development speed of the original sour gas field accumulation and size of the sequestration target. In one or more embodiments, sequestering sulfur oxides in an otherwise depleted geological formation 40 may be characterized as maintaining nearly 100% of the sulfur oxides for a timeframe of 1000 years or more. The detailed flow simulation, geochemical, and geomechanical modeling studies may need to be conducted for each specific site to assess technical and commercial feasibility.

### Gas Sweetening

In one or more embodiments, a geological formation 40 may be selected for the particular result of improving the quality of a gas within geological formation 40. For example, the introduction of sulfur oxides into a gas reservoir having high H₂S content can serve to sweeten hydrocarbons within geological formations 40 via the below reaction, which may be catalyzed by material available in the formation:

SO₂+2H₂S→3S+2H₂O.

### Enhanced Gas Recovery

In one or more embodiments, the sulfur oxides are sequestered, as described above, while also improving hydrocarbon gas and gas condensate recovery operations.

### Enhanced Oil Recovery

In one or more embodiments, a geological formation 40 may be selected for the particular result of utilizing the sulfur oxides with an enhanced oil recovery process. The properties of EOR processes are generally known to those skilled in the art. In these embodiments, the injected sulfur oxides may be used as a miscible agent. The injected sulfur oxides may also act as an immiscible agent, depending on reservoir pressure, temperature, and oil composition. One or more additional details may be disclosed in U.S. Pat. No. 4,217,955, which is incorporated herein by reference.

### INDUSTRIAL APPLICABILITY

It should be appreciated that embodiments of the present invention offer industrial applicability by providing advantageous methods of managing sulfur.

Various modifications and alterations that do not depart from the scope and spirit of this invention will become apparent to those skilled in the art. This invention is not to be duly limited to the illustrative embodiments set forth herein.

1. A method of managing sulfur in a sulfur-containing stream comprising the steps of:
(i) providing a sulfur-containing stream;
(ii) converting sulfur within the sulfur-containing stream to elemental sulfur;
(iii) transporting the elemental sulfur to a location at or near a sulfur oxide injection location;
(iv) converting the elemental sulfur to sulfur oxides;
(v) recovering electrical energy from said step of converting the elemental sulfur to sulfur oxides; and
(vi) injecting the sulfur oxides into the sulfur-oxide-injection location.

2. The method of claim 1, further comprising the steps of:
(vii) screening a plurality of injection locations, and
(viii) selecting, from the screened plurality of injection locations, a particular sulfur oxides injection location with specific reservoir characteristics for the sulfur oxides.

3. The method of claim 1, where the sulfur oxides include sulfur dioxide.

4. The method of claim 1, where the sulfur oxides include sulfur trioxide.

5. The method of claim 1, wherein the selection of the sulfur oxides injection location is based on a desired result to be achieved.

6. The method of claim 1, wherein the sulfur oxides injection location includes carbonate, wherein the desired result to be achieved is a step of forming calcium sulfate, calcium sulfite, or hydrated forms of calcium sulfate or calcium sulfite in the sulfur oxides injection location.

7. The method of claim 6, wherein the step of forming calcium sulfate, calcium sulfite or hydrated forms of calcium sulfate or calcium sulfite produces CO₂ for utilization with an enhanced oil recovery process.

8. The method of claim 1, wherein the sulfur oxides injection location is an otherwise depleted or substantially depleted geological formation, wherein the desired result to be achieved is a step of sequestering the sulfur oxides in the otherwise depleted or substantially depleted geological formation.

9. The method of claim 1, wherein the sulfur oxides injection location includes a gas containing hydrogen sulfide, wherein the desired result to be achieved is a step of reacting sulfur dioxide with the hydrogen sulfide in the gas containing hydrogen sulfide to thereby sweeten the gas containing hydrogen sulfide.

10. The method of claim 1, wherein the desired result to be achieved is a step of utilizing the injected sulfur oxides with an enhanced oil recovery (EOR) and/or enhanced gas recovery (EGR) process.

11. The method of claim 1, wherein the sulfur oxides made by said step of converting is in gaseous form and include sulfur dioxide, the method further comprising a step of further compressing the sulfur dioxide prior to said step of injecting, wherein the compressed, injected, and gaseous sulfur dioxide converts to liquid sulfur dioxide in situ in the sulfur oxides injection location.

12. The method of claim 1, wherein the sulfur-containing stream is a sour gas stream including hydrocarbons, carbon dioxide and hydrogen sulfide.

13. The method of claim 1, wherein the sulfur oxides made by said step of converting is liquefied prior to said step of injecting, such that said step of injecting includes injecting liquid sulfur oxides.

14. The method of claim 1, wherein the step of converting the elemental sulfur to sulfur oxides is a step of combusting the sulfur at the sulfur oxides injection location to thereby produce a combustion stream including sulfur oxides, wherein the step of recovering electrical energy includes steps of routing the combustion stream through a heat recovery unit to extract heat from the combustion stream and transfer the heat to a water or low-pressure steam stream to thereby form steam, and routing the steam to a turbine to thereby produce electrical energy.

15. A method of managing sulfur within a sour gas stream, the method comprising the steps of:
(i) transporting elemental sulfur from a first location to a location at or near a geological formation designated for sulfur sequestration;
(ii) combusting the sulfur at the location at or near the geological formation to thereby produce a combustion stream including sulfur oxides;
(iii) routing the combustion stream through a heat recovery unit to extract heat from the combustion stream;
(iv) producing electrical energy from the extracted heat;
(v) liquefying the sulfur oxides within the combustion stream to produce a liquefied sulfur oxides stream, and
(vi) selecting, from a plurality of injection locations, a particular sulfur oxides injection location; and
(vii) injecting the liquefied sulfur oxides stream into the particular sulfur oxides injection location.

16. A method of sequestering sulfur within a sour gas stream, the method comprising the steps of:
(i) providing a sour gas stream including hydrocarbons, carbon dioxide and hydrogen sulfide;
(ii) separating the hydrocarbons from the sour gas stream to produce a hydrocarbon stream and an acid gas stream including hydrogen sulfide;
(iii) oxidizing the hydrogen sulfide within the acid gas stream to produce sulfur oxides;
(iv) reacting the sulfur oxides with hydrogen sulfide to produce elemental sulfur;
(v) transporting the elemental sulfur to a location at or near desired geological formation;
(vi) combusting the elemental sulfur at or near the geological formation to thereby produce a combustion stream including sulfur oxides;
(vii) routing the combustion stream through a heat recovery unit to extract heat from the combustion stream and transfer the heat to a water or low-pressure steam stream to thereby form high pressure steam;
(viii) routing the steam to a turbine to thereby produce electrical energy;
(ix) liquefying the sulfur oxides within the combustion stream to produce a liquefied sulfur oxides stream, and
(x) injecting the liquefied sulfur oxides stream into the geological formation to thereby achieve sequestration of the sulfur oxides.

17. The method of claim 16, wherein the sequestration of the sulfur oxides is characterized as sequestering nearly 100% of the sulfur oxides for 1000 years or more.
